(19) United States
(12) Patent Application Publication
(10) Pub. No.: US 2007/0061549 A1
(43) Pub. Date: Mar. 15, 2007

(54) Method and an apparatus to track address translation in I/O virtualization

(76) Inventors: Narayanan G. Kaniyur, Newark, CA (US); Perey K. Wadia, Sunnyvale, CA (US); Debendra Das Sharma, Santa Clara, CA (US); Ronald L. Dammann, Palo Alto, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/228,687

(22) Filed: Sep. 15, 2005

(51) Int. Cl. G06F 12/00

(52) U.S. Cl. 711/207

(57) ABSTRACT

A method and an apparatus to track address translation in I/O virtualization have been presented. In one embodiment, the method includes initiating a page walk if none of a plurality of entries in a translation lookaside buffer (TLB) in a direct memory access (DMA) remap engine matches a guest physical address of an incoming address translation request. The method further includes performing the page walk in parallel with one or more ongoing page walks and tracking progress of the page walk using one or more of a plurality of flags and state information pertaining to intermediate states of the page walk stored in the TLB. Other embodiments have been claimed and described.

### TECHNICAL FIELD

Embodiments of the invention relate generally to computing systems, and more particularly, to input/output (I/O) virtualization.

### BACKGROUND

To meet the increasing computing demands of homes and offices, virtualization technology in computing has been introduced recently. In general virtualization technology allows a platform to run multiple operating systems and applications in independent partitions. In other words, one computing system with virtualization can function as multiple “virtual” systems. Furthermore, each of the virtual systems may be isolated from each other and may function independently.

Part of virtualization technology is input/output (I/O) virtualization. In platforms supporting I/O virtualization, address remapping is used to enable assignment of I/O devices to domains where each domain is considered to be an isolated environment in the platform. A domain is allocated a subset of the available physical memory and I/O devices allocated to that specific domain are allowed access to that memory. Isolation is achieved by blocking access from I/O devices not assigned to that specific domain.

The system view of physical memory may be different than each domain's view of its assigned physical address space. A set of translation structures provides the needed remapping between the domain's assigned physical address space (also known as guest physical address) to the system physical address (also known as host physical address). Thus a full address translation is a two-step process: In the first step, the I/O request is mapped to a specific domain (also known as context) based on the context mapping structures. In the second step, the guest physical address of the I/O request is translated to the host physical address based on the translation structures (also known as page tables) for that domain or context.

Direct memory access (DMA) remapping hardware (also referred to as DMA remap engine) is added to I/O hubs to perform the needed address translations in I/O virtualization. To enable efficient and fast address remapping, translation lookaside buffers (TLB) in DMA remap engine are used to store frequently used address translations. This speeds up an address translation by avoiding long latencies associated with main memory read operations otherwise needed to complete the address translation.

When address translation requests result in misses in the TLB, page walks are performed to retrieve the address translation from the main memory for the address translation requests. Depending on the platform addressing capabilities, a page walk may require one or more memory reads to fetch successive levels of page table entries. These intermediate page table entries are also cached in local caches to speed up the page walk latencies. The local caches include the context cache that holds device context information and appropriate number of non-leaf caches (L1, L2, L3 etc.) depending on the addressing capability of the platform. Different page walks may take different amounts of time to complete, and consequently, the page walks may not be completed in the order the corresponding address translation requests are received. However, the DMA remap engine has to respond to the address translation requests in the same order it received the address translation requests. To further complicate the issue, the DMA remap engine does not have an interrupt mechanism to handle out of order page walks, unlike conventional central processing units.

### BRIEF DESCRIPTION OF THE DRAWINGS

Embodiments of the present invention is illustrated by way of example and not limitation in the figures of the accompanying drawings, in which like references indicate similar elements and in which:

FIG. 1 shows one embodiment of an I/O hub;

FIG. 2A shows one embodiment of a process to track address translation in I/O virtualization;

FIG. 2B shows a state diagram of one embodiment of a process to prioritize TLB entries for de-allocation;

FIG. 3 shows one embodiment of a direct memory access (DMA) remap engine in an I/O hub;

FIG. 4 illustrates a flow diagram of one embodiment of a process to perform a page walk;

FIG. 5 illustrates an exemplary embodiment of a computing system; and

FIG. 6 illustrates an alternative embodiment of the computing system.

### DETAILED DESCRIPTION

A method and an apparatus to track address translation in input/output (I/O) virtualization are disclosed. In the following detailed description, numerous specific details are set forth in order to provide a thorough understanding. However, it will be apparent to one of ordinary skill in the art that these specific details need not be used to practice some embodiments of the present invention. In other circumstances, well-known structures, materials, circuits, processes, and interfaces have not been shown or described in detail in order not to unnecessarily obscure the description.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

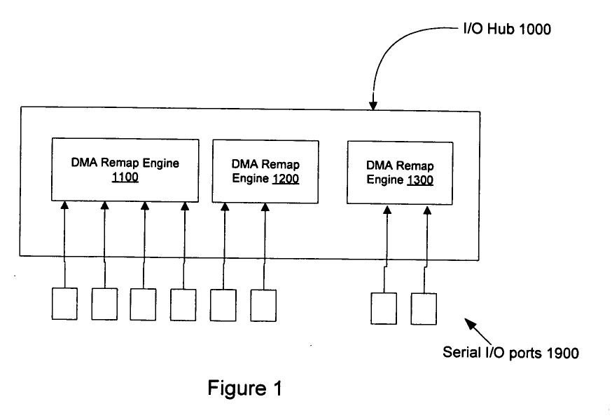

Based on design needs and performance considerations, one or more direct memory access (DMA) remap engines may be added to I/O hubs and assignment of DMA remap engines may be made to service translation requests from specific I/O ports in an I/O hub. This allows scaling of translation performance to meet product performance requirements. FIG. 1 shows one embodiment of an I/O hub. The I/O hub 1000 has three DMA remap engines 1100-1300. There are eight I/O ports 1900 coupled to the DMA remap engines 1100-1300. In one embodiment, four of the I/O ports 1900 are coupled to DMA remap engine 1100, two of the I/O ports 1900 are coupled to DMA remap engine 1200, and the remaining two are coupled to DMA remap engine 1300. Note that the assignment shown in FIG. 1 is merely one example of assignment. The I/O ports 1900 may be assigned in other ways to the DMA remap engines 1100-1300 in other embodiments.

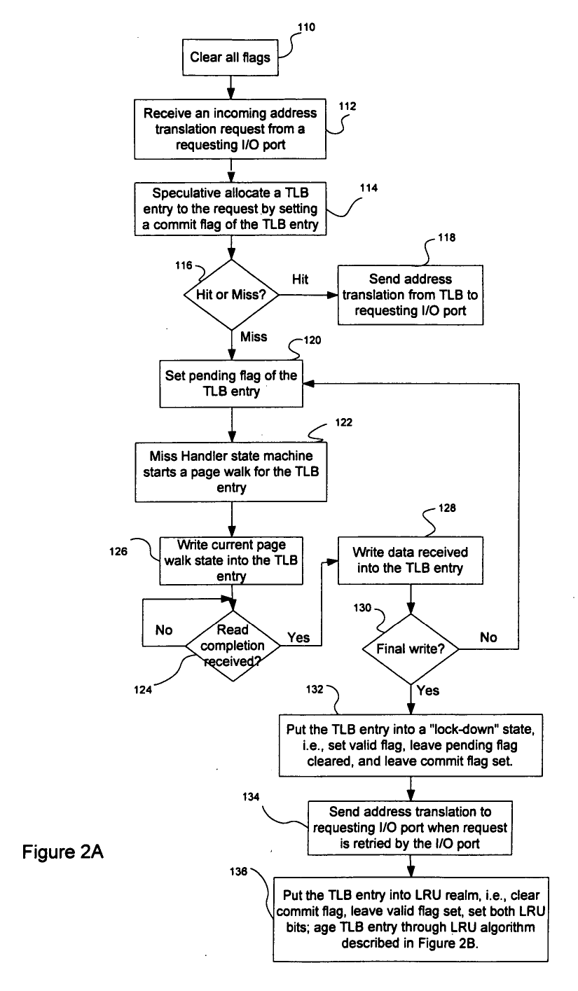

FIG. 2A shows one embodiment of a process to track address translation in I/O virtualization. The process is performed by processing logic that may comprise hardware (e.g., circuitry, dedicated logic, etc.), software (such as a program operable to run on a general-purpose computer system or a dedicated machine), firmware, or a combination of any of the above.

In I/O virtualization, different I/O ports may send address translation requests to associated DMA remap engines within an I/O hub in a computing system. In some embodiments, the DMA remap engine maintains a translation lookaside buffer (TLB) and caches to store frequently used address translation in order to speed up address translation. To keep track of address translation requests from different I/O ports as well as the progress of each address translation request, the DMA remap engine stores some flags (also known as sideband flags) to indicate the status of each TLB entry. Furthermore, processing logic in the DMA remap engine may track progress of page walks associated with the address translation requests, i.e., to determine the stages at which the page walk are at. In one embodiment, the flags are used to track the progress of page walks. The flags may include a commit flag, a pending flag, a valid flag, and a two-bit least-recently-used (LRU) flag (also referred to as the two LRU bits).

Initially, processing logic clears all flags in the TLB (processing block 110). In other words, all TLB entries are made invalid initially. Then the DMA remap engine may receive an incoming address translation request from a requesting I/O port (processing block 112). Processing logic may speculatively allocate a TLB entry to the address translation request by setting the commit flag of the TLB entry (processing block 114). Processing logic determines whether the address translation request has a hit or a miss in the TLB (processing block 116). If there is a hit, processing logic sends address translation from the TLB to the requesting I/O port (processing block 118).

If there is a miss, processing logic sets a pending flag of the TLB entry (processing block 120). In response to the pending flag set, a miss handler state machine starts a page walk for the TLB entry (processing block 122). A page walk process may include one or more local cache compares or read requests to main memory to fetch appropriate entries from page tables to enable address translation. This may include an initial compare or memory read request to map the address translation request to a specific domain based on the requesting I/O device and further compares or memory reads to perform a multi-level page walk depending on the platform addressing capabilities. As long as local caches result in a hit for a specific compare, the page walk keeps progressing to the next stage. If a local cache compare results in a miss, a memory read request is initiated for the appropriate page table entry. Once a read request is sent on the request bus, processing logic writes a current page walk state into the TLB entry (processing block 126) and can start to process a different TLB miss request. For the current TLB entry, processing logic waits at processing block 124 until a read completion is received. Processing logic may be processing other TLB entries while the current TLB entry is waiting for the read completion. In other words, processing logic may perform the current page walk of the current TLB entry in parallel with one or more ongoing page walks of the other TLB entries. The ongoing page walks may include page walks that are initiated before or after the current page walk such that the ongoing page walks and the current page walk overlap partially or entirely in time.

When the read completion is received, processing logic writes the data of the read completion received into the TLB entry (processing block 128). Processing logic checks whether this is a final write to complete the address translation (processing block 130). If not, the miss handler state machine sends at least one memory request. Hence, processing logic sets the pending flag of the TLB entry again to signal to the miss handler state machine that another page walk is going to be initiated for the TLB entry (processing block 120). Then processing logic repeats processing blocks 122-128 until the final write is done. After the final write, the address translation is available in the TLB entry. Thus, processing logic puts the TLB entry into a “lock-down” state so that the TLB entry would not be de-allocated (processing block 132). In some embodiments, processing logic sets the valid flag, clears the pending flag, and leaves the commit flag set to put the TLB entry into the “lock-down” state.

Processing logic services the address translation request by sending the address translation in the TLB entry to the requesting I/O port (processing block 134) when the request is retried. After servicing the address translation request, the TLB entry may be de-allocated, and hence, processing logic puts the TLB entry into a LRU realm. In some embodiments, processing logic clears the commit flag, leaves the valid flag set, and sets both bits of the LRU flag to put the TLB entry into the LRU realm. Once put into the LRU realm, the TLB entry may be prioritized with other TLB entries for de-allocation and allocation to some subsequently received address translation request.

FIG. 2B shows a state diagram of one embodiment of a process to prioritize TLB entries for de-allocation and allocation to some subsequently received address translation request. Once the address translation request matching a TLB entry is serviced, the TLB entry may be moved from the “lock-down” state into the LRU realm. As described above, each TLB entry may be associated with a number of flags stored in the TLB, which may include a two-bit least-recently-used (LRU) flag. Referring to FIG. 2B, the TLB entry in the LRU realm may be in one of four states. When the TLB entry first enters the LRU realm, both LRU bits may be set to put the TLB entry in state 210. As time passes, the TLB entry may move from a state with lower priority to a state with higher priority in being re-allocated to another address translation request. For example, the TLB entry may be moved from state 210 to state 220, and then to state 230 later. Finally, the TLB entry may be moved from state 230 to state 240. Once de-allocated, the TLB entry may be allocated again to another incoming address translation request.

In one embodiment, allocation priority of TLB entries to incoming address translation requests may be determined using a LRU timer. The LRU flags may be implemented using a counter that counts down with every tick of the LRU timer. Thus, a TLB entry in state 210 may be moved to state 220 upon a tick of the LRU timer. Likewise, the TLB entry may be moved from state 220 to state 230 upon another tick of the LRU timer. Then the TLB entry may be further moved from state 230 to state 240 upon another tick of the LRU timer.

In one embodiment, a hit to a valid entry in the LRU realm causes both LRU bits to be set again and the TLB entry returns to state 210 as illustrated in FIG. 2B. In one embodiment, the counter is restarted as the TLB entry returns to state 210.

In addition to allocation of TLB entries, the technique described above may be applied to de-allocation of TLB entries as well. In some embodiments, de-allocation of TLB entries follows a fixed priority. When there is one or more invalid TLB entries, an invalid TLB entry is selected for allocation to a newly received address translation request. If there are no invalid TLB entries, TLB entries in the LRU realm are considered for replacement based on their corresponding LRU bits. Referring back to the above example, the two LRU bits provide for four unique priority states (e.g., states 210-240) that are available for victimization. If no invalid entries and no TLB entries in the LRU realm are available, the TLB is considered full and the address translation request has to be retried later.

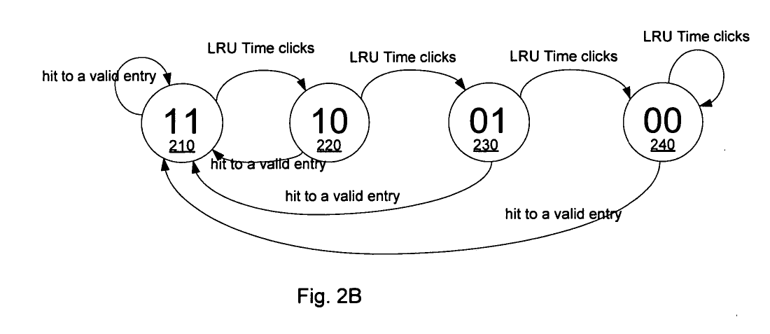

FIG. 3 illustrates one embodiment of a DMA remap engine in an I/O hub in a computing system. The DMA remap engine 300 includes a TLB 310, a miss handler state machine 320, and a non-leaf cache structure 330. The non-leaf cache structure 330 is coupled to the miss handler state machine 320. The miss handler state machine 320 is further coupled to the TLB 310. In one embodiment, the miss handler state machine 320 may be coupled to a memory read completion data bus 340 to receive memory read completion data from a main memory of the computing system. The miss handler state machine 320 may also be coupled to a memory request bus 350 to send memory read requests to the main memory.

In one embodiment, the TLB includes a tag memory 312, a register file 314, and queue tracking logic 316. The tag memory 312 holds incoming request addresses (also referred to as the guest physical address or GPA) that are going to be translated along with the requestor identification of the GPAs. The requestor identification may include various parameters, such as, for example, interconnect, device, function numbers from the corresponding interconnect transaction and is used to map the I/O request to a specific domain or context.

In addition to the tag memory 312, the TLB 310 also includes the register file 314. The register file 314 contains a number of TLB entries 314a as well as status bits 314b of the TLB entries 314a. The TLB entries 314a hold intermediate page walk states and/or the page-aligned translated address (also referred to as host physical address or HPA), depending on whether the page walk associated with a specific TLB entry is in progress or has completed. The TLB 310 may be coupled to a number of I/O ports, which are further coupled to a number of peripheral I/O devices (e.g., ethernet or other network controllers, storage controllers, audio coder-decoder, data input devices, such as keyboards, mouse, etc.).

Initially, a reset of the DMA remap engine 300 clears all of the flags such that all TLB entries 314a are in an invalid state. When the DMA remap engine 300 receives an incoming address translation request from one of the I/O ports, one of the TLB entries 314a is speculatively allocated to the incoming address translation request. Such allocation may also be referred to as victimization and the speculatively allocated TLB entry may also be referred to as a victim entry. In one embodiment, the victim entry is allocated by setting the commit flag of the victim entry. Furthermore, the parameters that may be used later in a page walk associated with the victim entry, such as the requestor identification and the incoming GPA, are written into the appropriate fields in both the tag memory 312 and the register file 314.

In one embodiment, the TLB 310 further includes processing logic 313 to compare the GPA in the incoming address translation request with the TLB entries 314a to determine if an address translation already exists or a page walk to enable this address translation is in progress in the TLB 310. If the address translation does exist, the corresponding translated HPA from the register file 314 is sent back to the requesting I/O device via the requesting I/O port to service the address translation request. If the page walk is in progress, the address translation request has to be retried later.

On the other hand, if the incoming address translation request does not have a valid address translation and no page walk is in progress to load the needed address translation in the TLB 310, a miss is confirmed. As described above, the commit flag of the victim entry has already been set. In one embodiment, the pending flag of the victim entry is also set in response to the confirmation of the miss to indicate to the miss handler state machine 320 that the victim entry is going to do a page walk to load a valid address translation. The page walk may include a sequence of memory read operations and/or cache lookups. Depending on the supported address widths for the platform of the computing system, the page walk may include different numbers of memory reads to complete the address translation in different embodiments.

In some embodiments, the miss handler state machine 320 performs a page walk to load a valid address translation into the victim entry. Furthermore, the miss handler state machine 320 tracks the victim entry through all stages of memory operations in the page walk. For example, when the victim entry is picked for service by the miss handler state machine 320, the pending flag of the victim entry is cleared. When the miss handler state machine 320 processes the page walk for the victim entry, the miss handler state machine 320 may send one or more memory read requests to the main memory. These memory read requests are tagged with the TLB index of the victim entry so that read completions coming back out-of-order may be clearly and correctly identified with the corresponding page walk.

In some embodiments, there is only one outstanding memory read request for a given TLB entry because the page walk is inherently a serial process. Since the miss handler state machine 320 cannot make progress on a page walk till the miss handler state machine 320 receives the memory read completions, the miss handler state machine 320 writes back the current state of the page walk to the register file 314 and leaves the pending flag of the victim entry cleared. This indicates that the victim entry cannot be serviced at this time. Then the miss handler state machine 320 is freed up to service other pending page walk requests of other TLB entries. Once the read completion is received for the page walk of the victim entry, the miss handler state machine 320 writes the data to the victim entry in the register file 314 and the pending flag is set again to indicate that the miss handler state machine 320 has to service the victim entry. The above series of operations may be repeated as the victim entry progresses through various stages of cache lookups and memory reads until the page walk is completed.

In some embodiments, the valid flag is set, the pending flag is cleared, and the commit flag is left set on the final write to complete the page walk for the victim entry. This indicates that a valid translation is present for the victim entry. The victim entry is now a valid entry and is put into a “lock-down” state and may not be further victimized. This helps to prevent thrashing of the TLB entry.

Once the address translation request has been serviced with the address translation in the victim entry, the victim entry may be moved from the “lock-down” state to the LRU realm. TLB entries in the LRU realm may be selected for victimization based on four possible priorities depending on the current LRU counter value, details of which have been described above with reference to FIG. 2B.

As mentioned above, when the miss handler state machine 320 is waiting for the memory read completion for a page walk of a TLB entry, the miss handler state machine 320 may service other pending page walk requests of other TLB entries. Thus, there may be multiple page walks in progress simultaneously at a given instance. In some embodiments, the queue tracking logic 316 keeps track of the multiple page walks. The queue tracking logic 316 may maintain a pointer to the earliest TLB entry that has not completed the page walk sequence. The pointer may also be referred to as the top-of-queue pointer.

In one embodiment, queue tracking logic 316 selects the first TLB entry starting from the top of queue that needs a memory operation as indicated by the pending flag being set for that TLB entry. Since a page walk may involve multiple cache lookups and main memory reads, a TLB entry corresponding to the page walk in the committed state may have its pending flag set and cleared multiple times as the page walk progresses through the appropriate combination of cache lookups and main memory reads to complete the page walk. Furthermore, the memory reads may be tagged with the TLB index of the TLB entry so that read completions coming back out-of-order may be clearly and correctly identified with a specific page walk.

Note that any or all of the components and the associated hardware of the DMA remap engine 300 illustrated in FIG. 3 may be used in various embodiments of the DMA remap engine 300. The embodiment shown in FIG. 3 merely serves as an example to illustrate the concept. However, it should be appreciated that other configurations of the DMA remap engine 300 may include more or less components than those shown in FIG. 3. For instance, the processing logic 313 may reside outside of the TLB 310 in another embodiment.

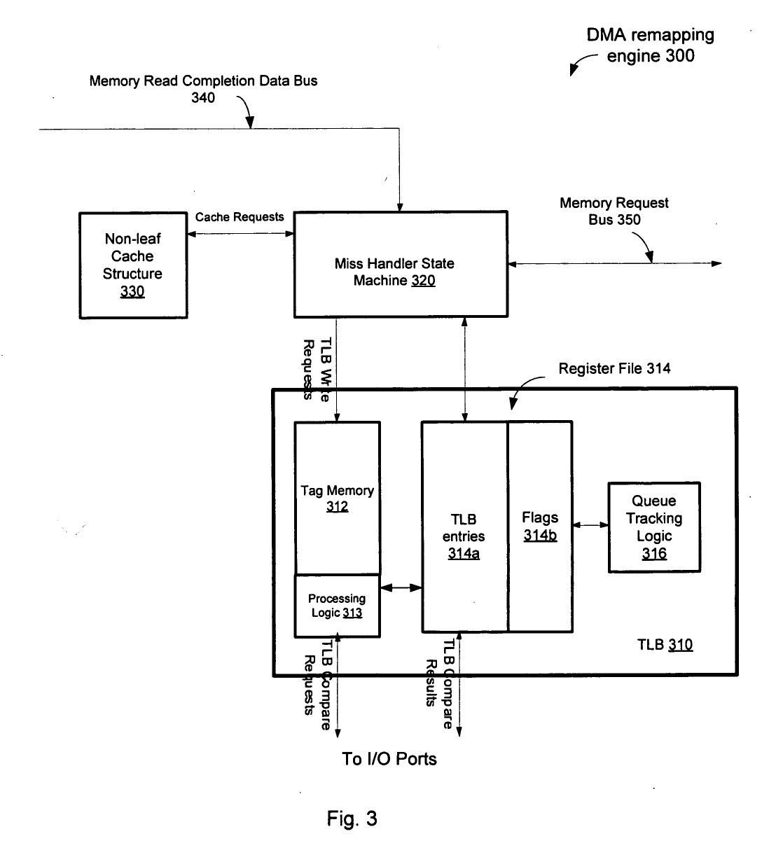

FIG. 4 shows a flow diagram of one embodiment of a process to perform a page walk for a TLB entry. The process is performed by processing logic that may comprise hardware (e.g., circuitry, dedicated logic, etc.), software (such as a program operable to run on a general-purpose computer system or a dedicated machine, such as the miss handler state machine 320 in FIG. 3), or a combination of both. In the following example, the computing system has four-level page table structures and the address translation request results in a TLB miss at the leaf level (i.e., level-4) and hits in all local caches.

Initially, the process starts at an idle state 410. In response to a page walk request, processing logic transitions to state 412. In state 412, a TLB entry is read out of the TLB to retrieve address translation information stored in the TLB entry, such as GPA, etc. Then a context cache compare is performed in state 414 to determine whether there is a hit. Processing logic then transitions to state 416 to wait for the results of the context cache compare. When the context cache compare determines that there is a hit, a first page walk compare is initiated to access level-1 (L1) cache at state 418. At state 420, processing logic waits for the results of the first page walk compare. Then it is determined that there is also a hit in the L1 cache, and hence, the processing logic goes into state 422 to initiate a second page walk compare to access level-2 (L2) cache. Processing logic then transitions to state 424 to wait for the results of the second page walk compare. When it is determined that there is also a hit in the L2 cache, processing logic transitions into state 426 to initiate a third page walk compare to access level-3 (L3) cache. Then processing logic waits for the results of the third page walk compare at state 428.

When it is determined that there is a hit in the L3 cache, processing logic transitions into state 430 to issue a final memory read request to access level-4 (L4) page table entry. Then processing logic transitions to state 432 to update the status bits of the TLB entry to mark the TLB entry as “not pending.” Then processing logic goes into the idle state at state 440. When the memory read completion is received for level-4 (L4) page table entry, processing logic goes into state 442 to read the TLB entry out of the TLB. Then processing logic writes back the completion and updates the flags of the TLB entry to mark the TLB entry as “pending” at state 444. Then processing logic becomes idle at state 446.

In some embodiments, processing logic remains in the idle state 446 and may later be asked to service the TLB entry that was previously marked “Pending”. Processing logic transitions into state 452 to read the TLB entry out of the TLB. Then processing logic updates the TLB entry in state 454 with the address translation based on the memory read completion received. After updating the TLB entry and the status of the entry, processing logic returns to an idle state in state 456. This completes the page walk for this translation request and the TLB entry is put in the “lock-down” state until the request is retried by the requesting port.

Note that the page walk described above is merely one example to illustrate the technique to track the progress of page walks using TLB entries and the associated flags. It should be appreciated that the technique may be applied to other computing systems having different levels of page table structures to accommodate the addressing capabilities of different platforms.

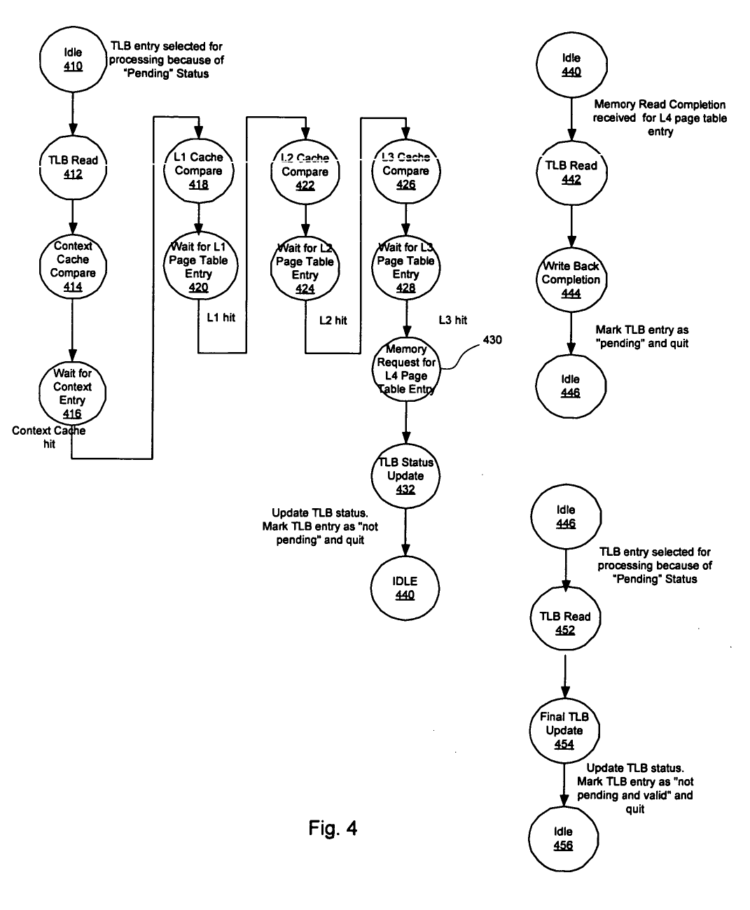

FIG. 5 shows an exemplary embodiment of a computer system 500 usable with some embodiments of the invention. The computer system 500 includes a processor 510, a memory controller 530, a memory 520, an input/output (I/O) hub 540, and a number of I/O ports 550. The memory 520 may include various types of memories, such as, for example, dynamic random access memory (DRAM), synchronous dynamic random access memory (SDRAM), double data rate (DDR) SDRAM, repeater DRAM, etc.

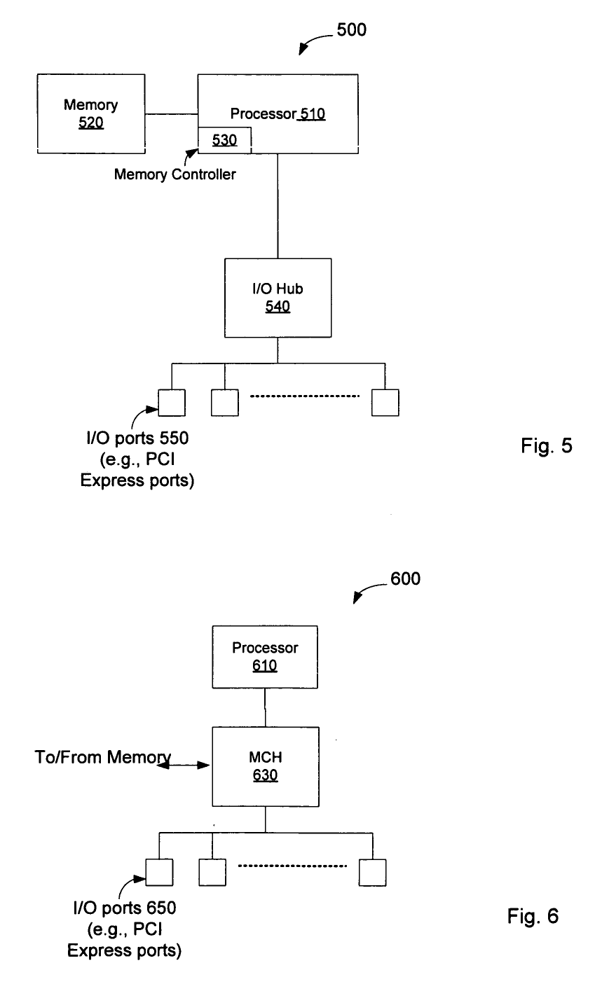

In some embodiments, the memory controller 530 is integrated with the I/O hub 540, and the resultant device is referred to as a memory controller hub (MCH) 630 as shown in FIG. 6. The memory controller and the I/O hub in the MCH 630 may reside on the same integrated circuit substrate. The MCH 630 may be further coupled to memory devices on one side and a number of I/O ports on the other side.

Furthermore, the chip with the processor 510 may include only one processor core or multiple processor cores. In some embodiments, the same memory controller 530 may work for all processor cores in the chip. Alternatively, the memory controller 530 may include different portions that may work separately with different processor cores in the chip.

Referring back to FIG. 5, the processor 510 is further coupled to the I/O hub 540, which is coupled to the I/O ports 550. The I/O ports 550 may include one or more Peripheral Component Interface Express (PCIE) ports. Through the I/O ports 550, the computing system may be coupled to various peripheral I/O devices, such as an audio coder-decoder, etc. Details of some embodiments of the I/O hub 540 have been described above with reference to FIG. 3.

In some embodiments, an address translation request needed to process in incoming I/O request to the I/O hub 540 is compared to the TLB entries in the DMA remap engine within the I/O hub 540. One of the TLB entries may be speculatively allocated to the address translation request. If none of the TLB entries matches a GPA in the address translation request, the address translation associated with the GPA is not available in the TLB and a miss is confirmed. In response to the miss, a page walk associated with the allocated TLB entry is initiated, whose progress is tracked using a number of flags associated with the TLB entry allocated. Furthermore, the page walk may be performed in parallel with a number of page walks initiated in response to other address translation requests being processed by the DMA remap engine.

More details of various embodiments of the processes to use the TLB as a translation tracking queue in I/O virtualization have been described in details above.

Note that any or all of the components and the associated hardware illustrated in FIG. 5 may be used in various embodiments of the computer system 500. However, it should be appreciated that other configurations of the computer system may include one or more additional devices not shown in FIG. 5. Furthermore, one should appreciate that the technique disclosed above is applicable to different types of system environment, such as a multi-drop environment or a point-to-point environment. Likewise, the disclosed technique is applicable to both mobile and desktop computing systems.

Some portions of the preceding detailed description have been presented in terms of symbolic representations of operations on data bits within a computer memory. These descriptions and representations are the tools used by those skilled in the data processing arts to most effectively convey the substance of their work to others skilled in the art. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations described herein. This apparatus may be specially constructed for the required purposes, or it may comprise a general-purpose computer selectively activated or reconfigured by a computer program stored in the computer. Such a computer program may be stored in a machine-accessible storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will appear from the description below. In addition, embodiments of the present invention are not described with reference to any particular programming language. It will be appreciated that a variety of programming languages may be used to implement the teachings as described herein.

The foregoing discussion merely describes some exemplary embodiments of the present invention. One skilled in the art will readily recognize from such discussion, the accompanying drawings and the claims that various modifications can be made without departing from the spirit and scope of the subject matter.

What is claimed is:

1. A method comprising:
initiating a page walk if none of a plurality of entries in a translation lookaside buffer (TLB) in a direct memory access (DMA) remap engine matches a guest physical address of an incoming address translation request;
performing the page walk in parallel with one or more ongoing page walks; and
tracking progress of the page walk using one or more of a plurality of flags and state information pertaining to intermediate states of the page walk stored in the TLB.

2. The method of claim 1, further comprising keeping track of an order of the page walk and the one or more ongoing page walks.

3. The method of claim 1, further comprising:
allocating an entry in the TLB to the incoming address translation request; and
tagging a plurality of memory operations of the page walk with an index of the entry allocated.

4. The method of claim 3, wherein the plurality of flags include a commit flag, a valid flag, a pending flag, and a least-recently-used (LRU) flag.

5. The method of claim 4, further comprising prioritizing de-allocation of the entry allocated using the LRU flag.

6. The method of claim 1, further comprising caching context and non-leaf page table entries in local caches coupled to the DMA remap engine to reduce latency of the page walk.

7. A machine-accessible medium that provides instructions that, if executed by a processor, will cause the processor to perform operations comprising:
initiating a page walk for one of a plurality of entries in a translation lookaside buffer (TLB) in a direct memory access (DMA) remap engine allocated to an incoming address translation request if none of the plurality of entries matches a guest physical address of the address translation request;
performing the page walk in parallel with one or more ongoing page walks; and
tracking progress of the page walk using one or more of a plurality of flags associated with the one entry allocated and state information pertaining to intermediate states of the page walk, the plurality of flags stored in the TLB.

8. The machine-accessible medium of claim 7, wherein the operations further comprise keeping track of an order of the page walk and the one or more ongoing page walks.

9. The machine-accessible medium of claim 7, wherein the operations further comprise
allocating an entry in the TLB to the incoming address translation request; and
tagging a plurality of memory operations of the page walk with an index of the entry allocated.

10. The machine-accessible medium of claim 9, wherein the plurality of flags include a commit flag, a valid flag, a pending flag, and a least-recently-used (LRU) flag.

11. The machine-accessible medium of claim 10, wherein the operations further comprise prioritizing de-allocation of the entry allocated using the LRU flag.

12. The machine-accessible medium of claim 7, wherein the operations further comprise caching context and non-leaf page table entries in local caches coupled to the DMA remap engine to reduce latency of the page walk.

13. An apparatus comprising:
a translation lookaside buffer (TLB) including a register file to store a plurality of entries and a plurality of flags and state information pertaining to intermediate states of the page walk; and
a miss handler state machine coupled to the TLB to initiate a page walk if none of the plurality of entries matches an incoming address translation request's guest physical address, to track progress of the page walk using the plurality of flags and the state information, and to perform the page walk in parallel with one or more ongoing page walks.

14. The apparatus of claim 13, wherein the TLB further comprises
a tag memory coupled to the register file to store the guest physical address of the incoming address translation request; and
processing logic coupled to the tag memory to compare the guest physical address with the plurality of entries.

15. The apparatus of claim 13, further comprising:
a queue tracking module coupled to the register file to keep track of an order of the page walk and the one or more ongoing page walks.

16. The apparatus of claim 13, wherein the plurality of flags include a commit flag, a valid flag, a pending flag, and a least-recently-used (LRU) flag.

17. The apparatus of claim 16, further comprising a least-recently-used (LRU) timer coupled to the TLB, wherein allocation and de-allocation priorities of the plurality of entries are determined using the LRU timer and the LRU flag.

18. A system comprising:
a memory;
a processor coupled to the memory; and
an input/output (I/O) hub coupled to the processor, wherein the I/O hub comprises one or more direct memory access (DMA) remap engines and each of the one or more DMA remap engines includes
a translation lookaside buffer (TLB) including a register file coupled to the tag memory to store a plurality of entries and a plurality of flags and state information pertaining to intermediate states of the page walk, and
a miss handler state machine coupled to the TLB to initiate a page walk if none of the plurality of entries matches an incoming address translation request's guest physical address, to track progress of the page walk using the plurality of flags and the state information, and to perform the page walk in parallel with one or more ongoing page walks.

19. The system of claim 18, wherein TLB further comprises
a tag memory coupled to the register file to store the guest physical address of the incoming address translation request;
processing logic coupled to the tag memory to compare the guest physical address with the plurality of entries; and
a queue tracking module coupled to the register file to keep track of an order of the page walk and the one or more ongoing page walks.

20. The system of claim 18, wherein the plurality of flags include a commit flag, a valid flag, a pending flag, and a least-recently-used (LRU) flag.

21. The system of claim 18, further comprising a memory controller, wherein the processor is coupled to the memory via the memory controller.

22. The system of claim 21, wherein the memory controller and the I/O hub reside on a single integrated circuit substrate.
